(19) United States
(12) Patent Application Publication
(10) Pub. No.: US 2026/0164095 A1
(43) Pub. Date: Jun. 11, 2026

(54) METHOD AND A SYSTEM FOR PROCESSING VIDEO CONTENT

(71) Applicant: Y.E. Hub Armenia LLC, Yerevan (AM)

(72) Inventor: Anatolii TOMILOV, Yekaterinburg (RU)

(21) Appl. No.: 19/179,033

(22) Filed: Apr. 15, 2025

(30) Foreign Application Priority Data
Apr. 15, 2024 (RU) 2024110236

(51) Int. Cl. H04N 21/81; G02B 27/01; G06T 3/4007; G06T 13/40; G06T 17/00

(52) U.S. Cl. CPC H04N 21/816; G02B 27/017; G06T 3/4007; G06T 13/40; G06T 17/00

(57) ABSTRACT

A method and a computing device for processing a video content are provided. The method comprises: receiving a raw sequence of frames representative of the video content including an animation of a 3D digital model of at least one object, the raw sequence of frames including a first plurality of frames configured for playback at a first frame rate; generating, based on the raw sequence of frames, an augmented sequence of frames representative of the animation of the 3D digital model, by: identifying, in a given pair of sequentially following frames of the raw sequence of frames, respective instances of the 3D digital model; based on the respective instances of the 3D digital model in the given pair of sequentially following frames, generating a synthetic instance of the 3D digital model; and placing the given synthetic frame between the given pair of sequentially following frames.

### CROSS-REFERENCE

The present application claims priority to Russian Patent Application No. 2024110236, entitled “Method and a System for Processing Video Content”, filed Apr. 15, 2024, the entirety of which is incorporated herein by reference.

### FIELD

The present technology relates generally to the field of video processing, and more particular, to methods and systems for processing video content for presentation thereof to users of head-mounted electronic devices.

### BACKGROUND

Head-mounted electronic devices, such as Virtual Reality (VR) or Augmented Reality (AR) helmet or glasses, are used to provide users thereof with an immersive video experience. Such devices are arranged to fully cover the area around the eyes of a user such that a viewport of the device, which is typically implemented wide-angle, is facing towards the eyes. Thus, a video content played back in the viewport of the head-mounted electronic device can either represent a completely virtual setting, as it is the case in VR technologies, or augment a real-world setting with certain details—for AR technologies.

Typically, responsive to current movements of the user's body, the video content can be live streamed (that is, in real time) to the head-mounted electronic device. Broadly, a process for providing the video content to the user of head-mounted electronic device can be described as follows: (i) the video content having a sequence of frames is composed at a server; (ii) the server is configured to compress the sequence of frames, such as by encoding, for transmission to the head-mounted electronic device, for example over the Internet; and (iii) the head-mounted electronic device is configured to decode the received video content and play it back to the user.

Typically, when decoded at the head-mounted electronic device, the video content is configured for a playback at a frame rate of 24 frames per second (FPS). However, certain applications of the head-mounted devices and related technologies (such as video games, healthcare, and virtual exhibitions, for example) may require that the video content to be played back in the viewport of the head-mounted electronic device be configured for higher frame rate, such as 48, 60, or even 72 FPS. Also, it has been shown that reproducing the video content in the head-mounted electronic device at the frame rate lower than 60 FPS may cause the user unpleasant sensations, such as nausea or dizziness, which may affect the experience of the user.

By contrast, the higher frame rate of reproducing the video content in the head-mounted electronic device may enable the user to appreciate a higher-quality, smoother picture in the viewport of the head-mounted electronic. Also, the higher frame rate of playing back the video content may provide for a more comfortable and satisfying user experience from appreciating the video content.

More specifically, if a given sequence of frames has been composed, at the server, to be played back at a frame rate of 48 FPS, then, when it is played back to the user in the viewport of the head-mounted electronic device at this frame rate, the user will perceive this video content as being smoother and more consistent compared to one that was composed for a playback at 24 FPS, that is, having twice as fewer frames per each second of the playback duration.

However, the head-mounted electronic devices typically have limited computational resources (such as those of a CPU and GPU), which may make it challenging to decode and play back video content configured for playback at the higher frame rate in real time. As a result, the user can perceive the video content as being slowed down or encounter delays in the playback of the video. This may affect the user experience of the user from interacting with the head-mounted electronic device.

Certain prior art approaches have been proposed to tackle the above-identified technical problem.

U.S. Pat. No.: 10,469,873-B2, issued on Nov. 5, 2019, assigned to Google LLC, and entitled “ENCODING AND DECODING VIRTUAL REALITY VIDEO,” discloses a virtual reality or augmented reality experience of a scene that may be decoded for playback for a viewer through a combination of CPU and GPU processing. A video stream may be retrieved from a data store. A first viewer position and/or orientation may be received from an input device, such as the sensor package on a head-mounted display (HMD). At a processor, the video stream may be partially decoded to generate a partially-decoded bitstream. At a graphics processor, the partially-decoded bitstream may be further decoded to generate viewpoint video of the scene from a first virtual viewpoint corresponding to the first viewer position and/or orientation. The viewpoint video may be displayed on a display device, such as screen of the HMD.

U.S. Pat. No.: 10,650,590-B1, issued on May 12, 2020, assigned to FastVDO LLC, and entitled “METHOD AND SYSTEM FOR FULLY IMMERSIVE VIRTUAL REALITY,” discloses methods and systems that use a video sensor grid over an area, and extensive signal processing, to create a model-based view of reality. Grid-based synchronous capture, point cloud generation and refinement, morphology, polygonal tiling and surface representation, texture mapping, data compression, and system-level components for user-directed signal processing, is used to create, at user demand, a virtualized world, viewable from any location in an area, in any direction of gaze, at any time within an interval of capture.

### SUMMARY

It is an object of the present technology to ameliorate at least some of the inconveniences present in the prior art.

The developers of the present technology have appreciated that, instead of receiving for further decoding the video content initially configured for playback at the higher frame rate, the head-mounted electronic device can be configured to augment a lower-quality video content that is configured for playback at the lower frame rate, for example, at 24 FPS. More specifically, after decoding the lower-quality video content, the present methods and systems are directed to generating synthetic intermediate frames to be placed between the decoded ones.

To that end, in at least some non-limiting embodiments of the present technology, a given synthetic frame is generated based on two neighboring decoded frames of the original video content, using for example, an interpolation algorithm. Thus, using the present methods and systems, the head-mounted electronic device can be configured to augment the initially received lower-quality video content, for example, that configured to be played back at 24 FPS, such that it is suitable for playback at 48 or even 72 FPS. As a result, the so generated augmented video content, when played back at the respective frame rate, has higher quality that the initially decoded one and hence allows the user to perceive a smoother moving picture when the so augmented video content is played back to the user.

The developers of the present technology have appreciated that such an approach to elevating the quality of the video content at the head-mounted electronic device may require less computational resources than decoding an video content initially suitable for playback at the higher frame rate; and as such, can help eliminate the associated disadvantages, such as user-perceivable delays and the slow playback. This may hence help improve the experience of users from interacting with the head-mounted electronic devices and appreciating the played back content.

More specifically, in accordance with a first broad aspect of the present technology, there is provided a computer-implemented method for processing a video content for presentation to a user of a head-mounted electronic device. The method comprises: causing the head-mounted electronic device to receive a raw sequence of frames representative of the video content including an animation of a 3D digital model of at least one object, the 3D digital object comprises a plurality of vertices defining a surface of the at least one object in each one of the raw sequence of frames; the raw sequence of frames including a first plurality of frames configured for playback at a first frame rate. The method further comprises causing the head-mounted electronic device to generate, based on the raw sequence of frames, an augmented sequence of frames representative of the animation of the 3D digital model, the generating comprising: generating content for a given synthetic frame, the generating comprising: identifying, in a given pair of sequentially following frames of the raw sequence of frames, respective instances of the 3D digital model; based on the respective instances of the 3D digital model in the given pair of sequentially following frames, generating a synthetic instance of the 3D digital model; and

placing the given synthetic frame between the given pair of sequentially following frames, thereby generating the augmented sequence of frames including a second plurality of frames configured for playback at a second frame rate, greater than the first frame rate.

In some implementations of the method, the generating the synthetic instance of the 3D digital model comprises determining, for each one of the plurality of vertices defining the surface of the 3D digital model, respective synthetic coordinates within the given synthetic frame. Determining the respective synthetic coordinates for a given vertex of the plurality of vertices comprises: determining first coordinates of the given vertex within the respective instance of the 3D digital model in a first frame of the given pair of sequentially following frames of the raw sequence of frames; determining second coordinates of the given vertex within the respective instance of the 3D digital model in a second frame of the given pair of sequentially following frames of the raw sequence of frames; applying, to the first coordinates, a first multiplier to generate first modified coordinates; applying, to the second coordinates, a second multiplier to generate second modified coordinates, the second multiplier being different from the first multiplier; and determining a combination between the first and second modified coordinates.

In some implementations of the method, each one of the first and second multipliers have been predetermined.

In some implementations of the method, each one of the first and second multipliers are less than 1.

In some implementations of the method, the second multiplier depends from the first multiplier.

In some implementations of the method, the second multiplier depends from the first multiplier according to a following equation:

t₂=1−t₁,

where t₁ is the first multiplier; and
t₂ is the second multiplier.

In some implementations of the method, the method further comprises modifying at least one of the first and second multipliers to generate an other synthetic frame; placing the given and other synthetic frames between the given pair of sequentially following frames, thereby generating the augmented sequence of frames including a third plurality of frames configured for playback at a third frame rate, greater than the second frame rate, during the given playback period.

In some implementations of the method, the determining, for each one of the plurality of vertices defining the surface of the 3D digital model, the respective synthetic coordinates within the given synthetic frame comprises applying a linear interpolation algorithm to coordinates of the plurality of vertices of the 3D digital model in the first and second frames of the given pair of sequentially following frames of the raw sequence of frames.

In some implementations of the method, the method further comprises causing the head-mounted electronic device to play back the augmented sequence of frames at the second frame rate.

In some implementations of the method, the generating the augmented sequence of frames is executed in real time, during the playback thereof.

In some implementations of the method, the head-mounted electronic device is one of Virtual Reality (VR) and Augmented Reality (AR) glasses.

In accordance with a second broad aspect of the present technology, there is provided a computing device for processing a video content for presentation to a user of the computing device. The computing device comprising at least one processor and at least one non-transitory computer-readable memory comprising executable instructions, which, when executed by the at least one processor, cause the computing device to execute steps of: receiving a raw sequence of frames representative of the video content including an animation of a 3D digital model of at least one object, the 3D digital object comprises a plurality of vertices defining a surface of the at least one object in each one of the raw sequence of frames; the raw sequence of frames including a first plurality of frames configured for playback at a first frame rate; and generating, based on the raw sequence of frames, an augmented sequence of frames representative of the animation of the 3D digital model, the generating comprising: generating content for a given synthetic frame, the generating comprising: identifying, in a given pair of sequentially following frames of the raw sequence of frames, respective instances of the 3D digital model; based on the respective instances of the 3D digital model in the given pair of sequentially following frames, generating a synthetic instance of the 3D digital model; and placing the given synthetic frame between the given pair of sequentially following frames, thereby generating the augmented sequence of frames including a second plurality of frames configured for playback at a second frame rate, greater than the first frame rate.

In some implementations of the computing device, to generate the synthetic instance of the 3D digital model, the at least one processor causes the computing device to determine, for each one of the plurality of vertices defining the surface of the 3D digital model, respective synthetic coordinates within the given synthetic frame, determining the respective synthetic coordinates for a given vertex of the plurality of vertices comprising: determining first coordinates of the given vertex within the respective instance of the 3D digital model in a first frame of the given pair of sequentially following frames of the raw sequence of frames; determining second coordinates of the given vertex within the respective instance of the 3D digital model in a second frame of the given pair of sequentially following frames of the raw sequence of frames; applying, to the first coordinates, a first multiplier to generate first modified coordinates; applying, to the second coordinates, a second multiplier to generate second modified coordinates, the second multiplier being different from the first multiplier; and determining a combination between the first and second modified coordinates.

In some implementations of the computing device, the second multiplier depends from the first multiplier according to a following equation:

t₂=1−t₁,

where t₁ is the first multiplier; and
t₂ is the second multiplier.

In some implementations of the computing device, the at least one processor further causes the computing device to: modify at least one of the first and second multipliers to generate an other synthetic frame; place the given and other synthetic frames between the given pair of sequentially following frames, thereby generating the augmented sequence of frames including a third plurality of frames configured for playback at a third frame rate, greater than the second frame rate, during the given playback period.

In some implementations of the computing device, to determine, for each one of the plurality of vertices defining the surface of the 3D digital model, the respective synthetic coordinates within the given synthetic frame, the at least one processor causes the computing device to apply a linear interpolation algorithm to coordinates of the plurality of vertices of the 3D digital model in the first and second frames of the given pair of sequentially following frames of the raw sequence of frames.

In some implementations of the computing device, the at least one processor causes the computing device to play back the augmented sequence of frames at the second frame rate.

In some implementations of the computing device, the at least one processor causes the computing device to generate the augmented sequence of frames in real time, during the playback thereof.

In some implementations of the computing device, the computing device is one of Virtual Reality (VR) and Augmented Reality (AR) glasses.

In some implementations of the computing device, the computing device is a server communicative coupled to a plurality of electronic devices, the server being configured to cause execution of the steps of (i) the receiving the raw sequence of frames; and (ii) the generating the augmented sequence of frames at a given one of the plurality of electronic devices.

In the context of the present specification, a “server” is a computer program that is running on appropriate hardware and is capable of receiving requests (e.g., from client devices) over a network, and carrying out those requests, or causing those requests to be carried out. The hardware may be one physical computer or one physical computer system, but neither is required to be the case with respect to the present technology. In the present context, the use of the expression a “server” is not intended to mean that every task (e.g., received instructions or requests) or any particular task will have been received, carried out, or caused to be carried out, by the same server (i.e., the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expression “at least one server”.

In the context of the present specification, “client device” is any computer hardware that is capable of running software appropriate to the relevant task at hand. Thus, some (non-limiting) examples of client devices include personal computers (desktops, laptops, netbooks, etc.), smartphones, and tablets, as well as network equipment such as routers, switches, and gateways. It should be noted that a device acting as a client device in the present context is not precluded from acting as a server to other client devices. The use of the expression “a client device” does not preclude multiple client devices being used in receiving/sending, carrying out or causing to be carried out any task or request, or the consequences of any task or request, or steps of any method described herein.

In the context of the present specification, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers.

In the context of the present specification, the expression “information” includes information of any nature or kind whatsoever capable of being stored in a database. This information includes, but is not limited to audiovisual works (images, movies, sound records, presentations etc.), data (location data, numerical data, etc.), text (opinions, comments, questions, messages, etc.), documents, spreadsheets, lists of words, etc.

In the context of the present specification, the expression “component” is meant to include software (appropriate to a particular hardware context) that is both necessary and sufficient to achieve the specific function(s) being referenced.

In the context of the present specification, the expression “computer usable information storage medium” is intended to include media of any nature and kind whatsoever, including RAM, ROM, disks (CD-ROMs, DVDs, floppy disks, hard drivers, etc.), USB keys, solid state-drives, tape drives, etc.

In the context of the present specification, the words “first”, “second”, “third”, etc. have been used as adjectives only for the purpose of allowing for distinction between the nouns that they modify from one another, and not for the purpose of describing any particular relationship between those nouns. Thus, for example, it should be understood that the use of the terms “first server” and “third server” is not intended to imply any particular order, type, chronology, hierarchy or ranking (for example) of/between the server, nor is their use (by itself) intended imply that any “second server” must necessarily exist in any given situation. Further, as is discussed herein in other contexts, reference to a “first” element and a “second” element does not preclude the two elements from being the same actual real-world element. Thus, for example, in some instances, a “first” server and a “second” server may be the same software and/or hardware, in other cases they may be different software and/or hardware.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 depicts a schematic diagram of an example computer system for implementing certain non-limiting embodiments of systems and/or methods of the present technology;

FIG. 2 depicts a networked computing environment suitable for some implementations of certain non-limiting embodiments the present technology;

FIG. 3 depicts a schematic diagram of a raw video sequence of given video content to be transmitted from a server to an electronic device present the networked computing environment of FIG. 2, in accordance with certain non-limiting embodiments of the present technology;

FIG. 4 depicts a schematic diagram of portions of the raw video sequence of FIG. 3 and an augmented video sequence for a one-second duration playback, in accordance with certain non-limiting embodiments of the present technology;

FIG. 5 depicts a schematic diagram of the raw video sequence of FIG. 3 illustrating a pair sequentially following raw frames thereof, in accordance withe certain non-limiting embodiments of the present technology;

FIG. 6 depicts a schematic diagram of the augmented video sequence generated, by one of the server and the electronic device present in the networked computing environment of FIG. 2, by inserting at least one synthetic frame between the pair sequentially following raw frames illustrated in FIG. 5, in accordance with certain non-limiting embodiments of the present technology; and

FIG. 7 depicts a flow chart of a method for processing, by one of the server and the electronic device present in the networked computing environment of FIG. 2, the given video content of FIG. 3, in accordance with the non-limiting embodiments of the present technology.

### DETAILED DESCRIPTION

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope.

Furthermore, as an aid to understanding, the following description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the present technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labeled as a “processor” or a “graphics processing unit,” may be provided through the use of dedicated hardware as well as hardware capable of executing software in association with appropriate software. When provided by a processor, the functions may be provided by a single dedicated processor, by a single shared processor, and/or by a plurality of individual processors, some of which may be shared. In some embodiments of the present technology, the processor may be a general-purpose processor, such as a central processing unit (CPU) or a processor dedicated to a specific purpose, such as a graphics processing unit (GPU). Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random-access memory (RAM), and/or non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown.

With these fundamentals in place, we will now consider some non-limiting examples to illustrate various implementations of aspects of the present technology.

### Computer System

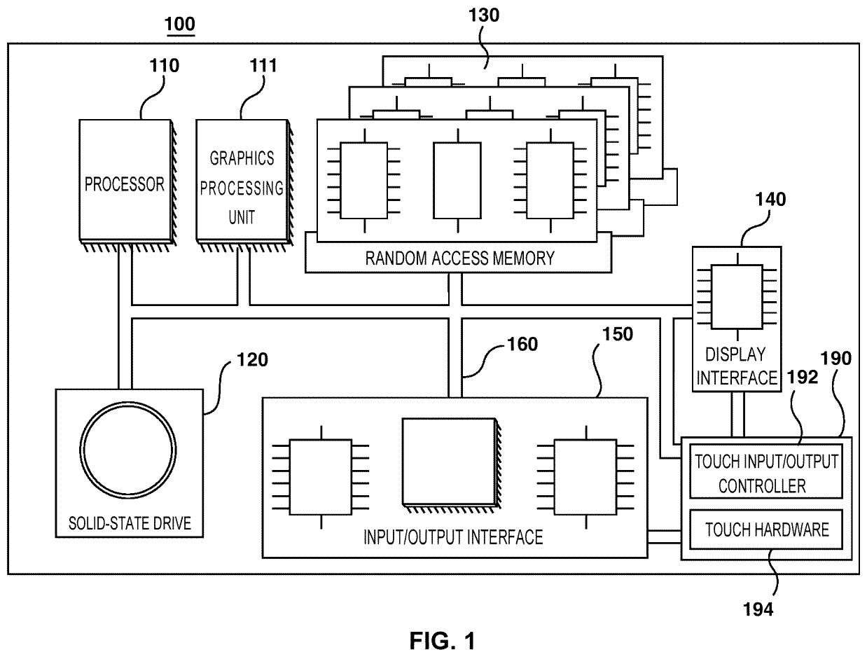

With reference to FIG. 1, there is depicted a computer system 100 suitable for use with some implementations of the present technology. The computer system 100 comprises various hardware components including one or more single or multi-core processors collectively represented by processor 110, a graphics processing unit (GPU) 111, a solid-state drive 120, a random-access memory 130, a display interface 140, and an input/output interface 150.

Communication between the various components of the computer system 100 may be enabled by one or more internal and/or external buses 160 (e.g. a PCI bus, universal serial bus, IEEE 1394 “Firewire” bus, SCSI bus, Serial-ATA bus, etc.), to which the various hardware components are electronically coupled.

The input/output interface 150 may be coupled to a touchscreen 190 and/or to the one or more internal and/or external buses 160. The touchscreen 190 may be part of the display. In some embodiments, the touchscreen 190 is the display. In the embodiments illustrated in FIG. 1, the touchscreen 190 comprises touch hardware 194 (e.g., pressure-sensitive cells embedded in a layer of a display allowing detection of a physical interaction between a user and the display) and a touch input/output controller 192 allowing communication with the display interface 140 and/or the one or more internal and/or external buses 160. In some embodiments, the input/output interface 150 may be connected to a keyboard (not shown), a mouse (not shown) or a trackpad (not shown) allowing the user to interact with the computer system 100 in addition to or instead of the touchscreen 190. In some embodiments, the computer system 100 may comprise one or more microphones (not shown). The microphones may record audio, such as user utterances. The user utterances may be translated to commands for controlling the computer system 100.

It is noted some components of the computer system 100 can be omitted in some non-limiting embodiments of the present technology. For example, the touchscreen 190 can be omitted, especially (but not limited to) where the computer system is implemented as a smart speaker device.

According to implementations of the present technology, the solid-state drive 120 stores program instructions suitable for being loaded into the random-access memory 130 and executed by the processor 110 and/or the GPU 111. For example, the program instructions may be part of a library or an application.

### Networked Computing Environment

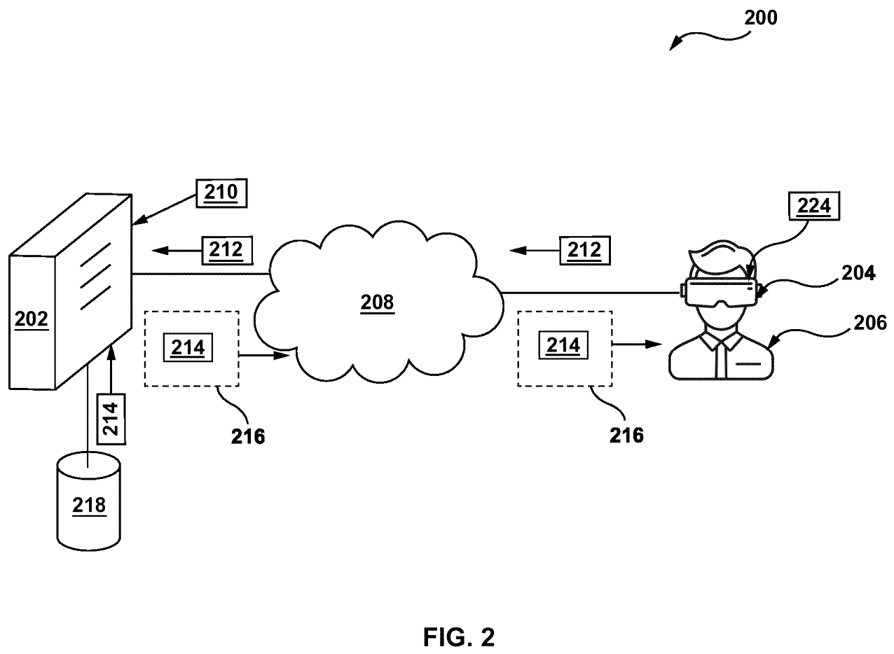

With reference to FIG. 2, there is depicted a schematic diagram of a networked computing environment 200 suitable for use with some embodiments of the systems and/or methods of the present technology. In some non-limiting embodiments of the present technology, the networked computing environment 200 can be configured to generate and process video content.

To that end, in some non-limiting embodiments of the present technology, the networked computing environment 200 comprises a server 202 communicatively coupled, via a communication network 208, to an electronic device 204. In the non-limiting embodiments of the present technology, the electronic device 204 may be associated with a user 206.

In some non-limiting embodiments of the present technology, the server 202 is implemented as a conventional computer server and may comprise some or all of the components of the computer system 100 of FIG. 1. In one non-limiting example, the server 202 is implemented as a Dell™ PowerEdge™ Server running the Microsoft™ Windows Server™ operating system, but can also be implemented in any other suitable hardware, software, and/or firmware, or a combination thereof. In the depicted non-limiting embodiments of the present technology, the server 202 is a single server. In alternative non-limiting embodiments of the present technology (not depicted), the functionality of the server 202 may be distributed and may be implemented via multiple servers.

Further, the electronic device 204 may be any computer hardware that is capable of running a software appropriate to the relevant task at hand and can also comprise some or all components of the computer system 100 depicted in FIG. 1. Thus, some non-limiting examples of the electronic device 204 may include personal computers (desktops, laptops, netbooks, etc.), smartphones, and tablets.

In some non-limiting embodiments of the present technology, the electronic device 204 can be a head-mounted electronic device (also referred to herein as a head-mounted display, HMD). Broadly speaking, the head-mounted electronic device is an electronic device that is arranged to be worn over eyes of the user 206 and having, on a surface facing thereto, a display (also referred to herein as a “viewport”) configured for playing various video content that may be representative of various simulated environments. For example, in various non-limiting embodiments of the present technology, the head-mounted electronic device can be integrated in a helmet or glasses that the user 206 can put on over their eyes. Typically, the head-mounted electronic device comprises sensors configured to track movements of at least one of a body, a head, and pupils of the eyes of the user 206, data from which the head-mounted electronic device can be configured to use either to adjust parameters of a current video content or receive and play back an other video content, thereby providing the user 206 with simulated experience.

Further, in some non-limiting embodiments of the present technology, when worn over the eyes of the user 206, the head-mounted electronic device can be configured to fully block a vision of the user 206 providing thereto a simulated environment by playing back the respective video content. In these embodiments, the head-mounted electronic device can be referred to as a Virtual Reality (VR) head-mounted electronic device. In other non-limiting embodiments of the present technology, the head-mounted electronic device can be configured to block the vision of the user 206 only partially and play back such video content in the viewport of the head-mounted electronic device that would superimpose with an actual environment currently observed by the user 206. In these embodiments, the head-mounted electronic device can be referred to as an Augmented Reality (AR) head-mounted electronic device. Various applications of the head-mounted electronic device can include, without limitation, (1) video games, such as those where the user 206 is playing from the first-person perspective; (2) arts, for example, for conducting virtual tours to museums; and (3) medicine, such as for simulating surgical scenarios.

Specific examples of the head-mounted electronic device include, without limitation, a Meta™ Quest™ head-mounted electronic device, an Amazon™ Oculus™ head-mounted electronic device, and an HTC™ Vive™ Pro head-mounted electronic device. Overall, in these embodiments, the electronic device 204 can be configured to play back an immersive VR or AR video content to the user 206.

Also, it should be expressly understood that the electronic device 204 can be one of a plurality of electronic devices, similar to the electronic device 204, which are communicatively coupled to the server 202, for playing back the video content from the server 202.

According to certain non-limiting embodiments of the present technology, the video content for reproduction at the electronic device 204 can be provided by the server 202. Thus, in some non-limiting embodiments of the present technology, the server 202 can be under control of an entity producing certain video content for distribution thereof to end users via the communication network 208, such as the user 206. More specifically, in these embodiments, the server 202 can be used for composing and/or storing already generated video content and cause transmission thereof to the electronic device 204, for example, upon a respective request therefrom. A format of the video content provided by the server 202 is also not limited can include, for example, MP4, MOV, and F4V.

Thus, according to certain non-limiting embodiments of the present technology, the electronic device 204 can be configured to transmit, over the communication network 208, a video content request 212 to the server 202; and in response thereto, the server 202 can be configured to: (i) identify, in a video content database 218, a given video content 214 responsive to the video content request 212; (ii) compress the given video content 214 to generate a compressed video data package 216; and (iii) transmit the compressed video data package 216 to the electronic device 204 for further presentation of the given video content 214 to the user 206.

It is not limited how the electronic device 204 can be configured to cause submission of the video content request 212 to the server 202. In some non-limiting embodiments of the present technology, the video content request 212 can be explicitly submitted by the user 206 using, for example, a corresponding actuator of a graphical user interface provided by the electronic device 204. Depending on a particular application of the electronic device 204, in these embodiments, the video content request 212 can be indicative, for example, of one of (1) starting up a new playing session of a video game; (2) a tour in the Metropolitan Museum of Arts; or (3) launching a simulation of a particular surgical scenario. In other non-limiting embodiments of the present technology, the video content request 212 can be triggered automatically—such as in response to a given movement of the user 206 during reproduction of the current video content. In these embodiments, the video content request 212 can be indicative, for example, of requesting an additional video content corresponding to a currently observable portion of the simulated environment of the user 206, such as that in the viewport of the head-mounted electronic device.

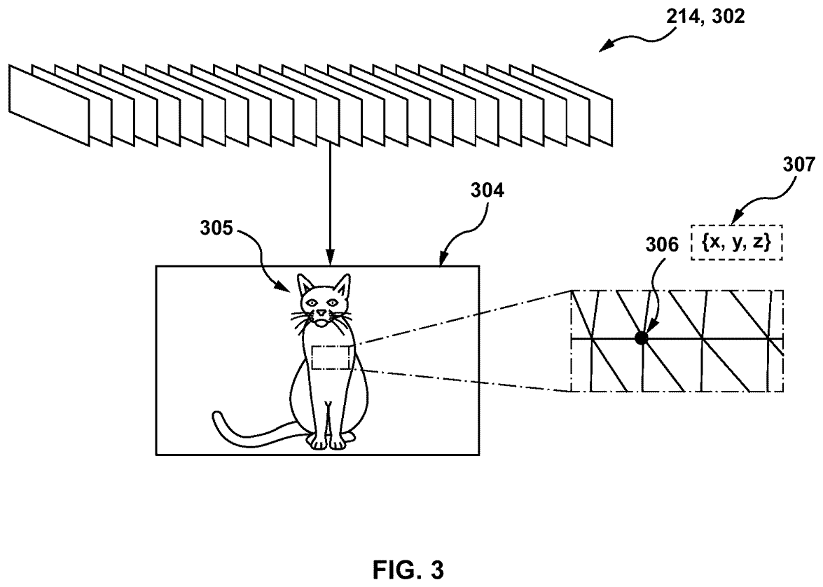

With reference to FIG. 3, there is depicted a schematic diagram of the given video content 214, in accordance with certain non-limiting embodiments of the present technology.

According to certain non-limiting embodiments of the present technology, the given video content 214 can be a 3D VR or AR video content, and as such, can be represented as comprising two separate elements: (1) a raw video sequence 302 having 2D frames; and (2) a plurality of vertices (such as a given vertex 306) defining a surface of a 3D digital object animated in the given video content 214, such as a given digital object 305.

As it can be appreciated the raw video sequence 302 comprises a plurality of raw 2D frames, each of which includes a respective instance of the given digital object 305 such that when the raw video sequence 302 is played back, it defines a moving picture of the given video content 214.

In some non-limiting embodiments of the present technology, the given raw frame 304 includes pixels representative of a 2D image of the respective instance of the given digital object 305. A number of pixels can be defined by a respective image resolution of the given raw frame 304. In various non-limiting embodiments of the present technology, the respective image resolution of the given raw frame 304 can be, without limitation, Full HD (1920×1080 pixels), 2K (2048×1080 pixels), 4K (3840×2160 pixels), or 8K (7680×4320 pixels).

In some non-limiting embodiments of the present technology, the given digital object 305 can comprise a 3D point cloud having a plurality of vertices defining a surface of the given digital object 305. In other non-limiting embodiments of the present technology, the given digital object 305 can comprise a 3D mesh having a plurality of mesh elements defining the surface of the given digital object 305. For example, the plurality of mesh elements can be generated by connecting vertices of the 3D point cloud by edges. According to certain non-limiting embodiments of the present technology, the plurality of mesh elements can include, without limitation, triangular mesh elements, quadrilateral mesh elements, convex polygonal mesh elements, or even concave polygonal mesh elements, as an example, without departing from the scope of the present technology. Also, in some non-limiting embodiments of the present technology, the vertices can be distributed uniformly along the surface of the given digital object 305. In other non-limiting embodiments of the present technology, the vertices can be randomly scattered along the surface of the given digital object 305.

Further, with continued reference to FIG. 3 and with back reference to FIG. 2, according to certain non-limiting embodiments of the present technology, to generate the compressed video data package 216 for further transmission thereof to the electronic device 204, the server 202 can be configured to: (1) compress the raw video sequence 302 using one or more video encoding algorithms; and (2) for each frame of the raw video sequence 302, store vertex coordinates of each vertex of the given digital object 305. In some non-limiting embodiments of the present technology, the one or more video encoding algorithms, can include an H.264, H265, or a High Efficiency Video Coding (HVEC) video encoding algorithm.

Thus, when the electronic device 204 receives the compressed video data package 216, to restore the given video content 214, the electronic device 204 can be configured to: (i) decode the compressed video package 216 to restore the raw sequence of frames 302; (ii) identify, in the given raw frame 304 of the raw video sequence 302, a given mesh element of the given digital object 305 using vertex coordinates thereof; and (ii) apply, to the given mesh element a respective value of a textural parameter of the given raw frame 304. In other words, when restoring the given video content 214, the electronic device 204 can be configured to use the given raw frame 304 as a 2D texture atlas for the respective instance of the given digital object 305.

According to certain non-limiting embodiments of the present technology, the electronic device 204 can be configured to decode the raw video sequence 302 by using a same encoding algorithm that was used for encoding the given video content 214 by the server 202 for transmission to the electronic device 204. According to certain non-limiting embodiments of the present technology, the textural parameter can include at least one of: (1) a color to be applied to a given mesh element, for example, in the RGB scale; (2) a transparency value to be applied to the given mesh element; and (3) a light intensity value to be applied to the given mesh element; and others.

Further, once the electronic device 204 has restored the given video content 214 the electronic device 204 can be configured to play back the given video content 214 to the user 206.

However, as certain application may require playback of the given video content 214 at the electronic device 204 at a higher frame rate, such as 48, 60, or even 72 FPS, decoding such high-quality compressed video data can be a very computationally-intensive task for the processor 110 or the GPU 111 of the electronic device 204.

As a result, during the presentation of such video content, due to the limited computational resources of the electronic device 204, the user 206 can perceive delays in the playback of the given video content 214 or perceive the given video content 214 as being slowed down, which may affect the user experience of the user 206 from interacting with the electronic device 204 or with an entity associated with producing and providing the video content via the server 202.

To that end, the developers of the present technology have appreciated that the given video content 214 can be transmitted to the electronic device 204 in a lower quality, such as that suitable for a playback speed of 24 FPS and lower; and after decoding, can be augmented. More specifically, as will be described in greater detail below, after decoding the compressed video data package 216 of the given video content 214, the present methods and systems are directed to causing the electronic device 204 to generate and add, to the raw video sequence 302, intermediate synthetic frames, content of which is generated based on the original raw frames of the given video content 214, thereby generating an augmented video content 224. Thus, an increased number of frames may enable a proportional increase in the playback speed for the augmented video content 224, which, in turn, causes the quality of the played back video content to increase as well. Therefore, the user 206 can perceive the augmented video content 224, when it is played back on the electronic device 204, as being smoother compared to the playback of the given video content 214 and more realistically responsive to movements of the user 206. This may enhance user-satisfaction from using the electronic device 204 and appreciating the given digital content 214.

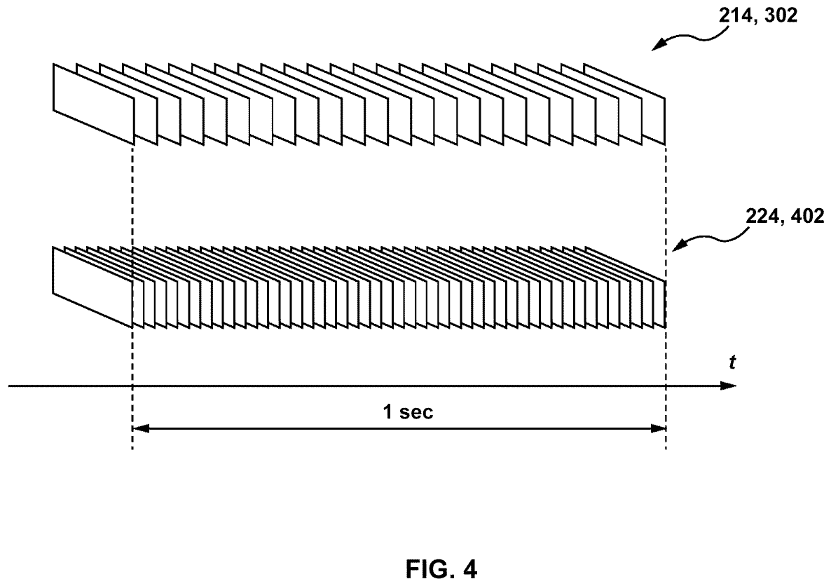

For example, with reference to FIG. 4, there is depicted a schematic diagram of portions of the raw video sequence 302 of the given video content 214 and of an augmented video sequence 402 of the augmented video content 224 corresponding to a one-second playback duration, in accordance with certain non-limiting embodiments of the present technology.

More specifically, as best shown in FIG. 4, if the given video content 214 is initially configured for a playback at 24 FPS, the electronic device 204 can be configured to generate and place, between each given pair of sequentially following raw frames of the raw video sequence 302 that has been decoded, a respective intermediate synthetic frame, generated based on content of the given pair of sequentially following raw frames. By doing so, the electronic device 204 can be configured to double a number of frames for a given playback second in the augmented video sequence 402, which enables increasing the playback speed thereof to 48 FPS. Similarly, if the electronic device 204 is caused, for example, by the server 202, to generate and add two intermediate synthetic frames between the given pair of sequentially following frames of the raw video sequence 302, the playback speed of the augmented video sequence 402 can be increased to 72 FPS.

Thus, when the user 206 is appreciating the augmented video content 224 played at the higher frame rate, he or she may perceive a resulting moving picture as being smoother, compared to the given video content 214, without altered perception of the content thereof. By doing so, the present methods and systems may allow for an uninterrupted reproduction of high-quality video content at the electronic device 204, requiring less computational resources thereof, which may allow improving the user experience of the user 206 from interacting with the electronic device 204 and/or entities associated with the provided video content.

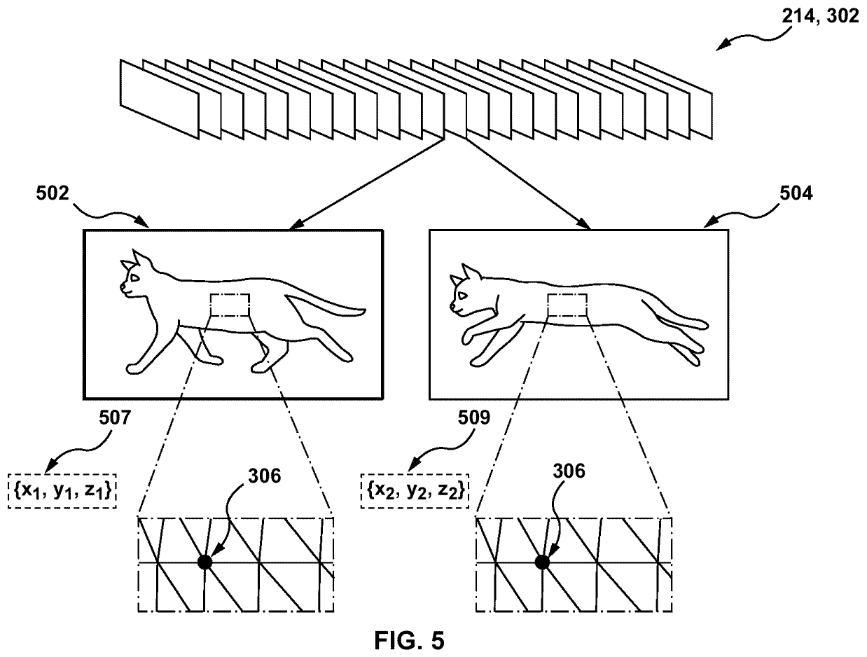

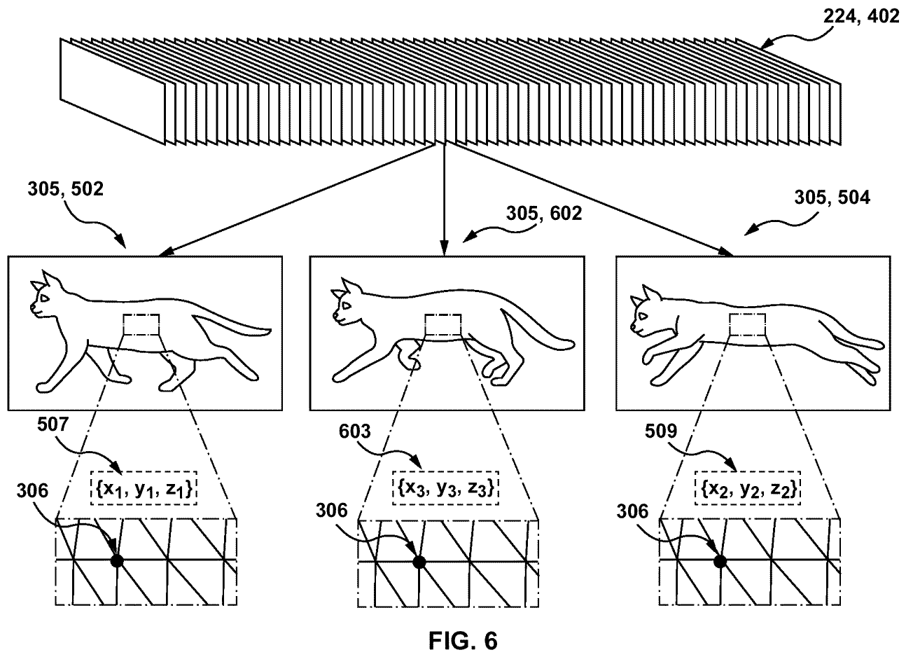

How the synthetic frames are generated and added to the given video content 214 to increase the perceived quality thereof, in accordance with certain non-limiting embodiments of the present technology, will be described below with reference to FIGS. 5 to 6.

### Communication Network

In some non-limiting embodiments of the present technology, the communication network 208 is the Internet. In alternative non-limiting embodiments of the present technology, the communication network 208 can be implemented as any suitable local area network (LAN), wide area network (WAN), a private communication network or the like. It should be expressly understood that implementations for the communication network 208 are for illustrative purposes only. How a respective communication link (not separately numbered) between each one of the server 202, the electronic device 204, and the communication network 208 is implemented will depend, inter alia, on how each one of the server 202 and the electronic device 204 is implemented. Merely as an example and not as a limitation, in those embodiments of the present technology where the electronic device 204 is implemented as a wireless communication device such as a smartphone, the communication link can be implemented as a wireless communication link. Examples of wireless communication links include, but are not limited to, a 3G communication network link, a 4G communication network link, and the like. The communication network 208 may also use a wireless connection with the server 202.

### Synthetic Frame Generation

With reference to FIG. 5, there is depicted a schematic diagram of the raw video sequence 302 of the given video content 214 illustrating a given pair of sequentially following raw frames thereof, in accordance with certain non-limiting embodiments of the present technology. As mentioned herein above, the raw video sequence 302 can be configured for a lower-frame rate playback, such as 24 FPS. In other words, in this case, the raw video sequence 302 has a first number of frames that has been determined such that every second of the playback duration of the given video content 214, when it is being played back at 24 FPS, has 24 frames.

As mentioned hereinabove with reference to FIG. 3, according to certain non-limiting embodiments of the present technology, after decoding the compressed video data package 216 received from the server 202, aside from reconstructed raw frames of the raw video sequence 302, the electronic device 204 can be configured to receive the information on how the content of the given video content 214 is represented therein, such as that of the given digital object 305. More specifically, according to certain non-limiting embodiments of the present technology, the electronic device 204 can be configured to receive, for each raw frame of the raw video sequence 302, respective coordinates of each vertex defining the surface of the given digital object 305, such as the given vertex 306. However, in other non-limiting embodiments of the present technology, instead of receiving the coordinates from the server 202, the electronic device 204 can be configured to determine the respective coordinates of the given vertex 306 in each raw frame of the raw video sequence 302. Further, using these coordinates, the electronic device 204 can be configured to generate synthetic instances of the given digital object 305 for synthetic frames of the augmented video sequence 402.

To that end, according to certain non-limiting embodiments of the present technology, the electronic device 204 can be configured to: (i) identify, in the raw video sequence 302, the given pair of sequentially following raw frames including a fist raw frame 502 and a second raw frame 504; (ii) identify, in each one of the first and second raw frames 502, 504, the respective instance of the given digital object 305; (iii) retrieve (or otherwise determine) first raw coordinates 507 and second raw coordinates 509 of the given vertex 306 defining the surface of the respective instance of the given digital object 305 in each one of the first and second raw frames 502, 504; and (iv) based on the first and second raw coordinates, determine synthetic coordinates for the given vertex 306 of a respective synthetic instance of the given digital object 305.

With reference to FIG. 6, there is depicted a schematic diagram of generating, by the electronic device 204, a given synthetic frame 602 for generating the augmented video sequence 402, in accordance with certain non-limiting embodiments of the present technology.

In some non-limiting embodiments of the present technology, the electronic device 204 can be configured to determine respective synthetic coordinates 603 of the given vertex 306 in the given synthetic frame 602 by determining a combination of the first and second raw coordinates 507, 509 of the given vertex 306 in the first and second raw frames 502, 504. In some non-limiting embodiments of the present technology, the combination of the first and second raw coordinates 507, 509 comprises an average value thereof. In other non-limiting embodiments of the present technology, the combination of the first and second raw coordinates 507, 509 comprises a weighted average value thereof.

More specifically, in some non-limiting embodiments of the present technology, the electronic device 204 can be configured to (i) assign, to each one of the first and second raw coordinates 507, 509, a first and second multiplier, respectively; and (ii) determine the average value of the so weighted raw coordinates. In some non-limiting embodiments of the present technology, the first and second multipliers can be equal. In other non-limiting embodiments of the present technology, the first and second multipliers to be assigned to the first and second raw coordinates 507, 509 can be different. It is not limited how the first and second multipliers can be selected; and in some non-limiting embodiments of the present technology, these multipliers can be selected empirically, maximizing at least one of a quality of the given synthetic frame 602 or the augmented video sequence 402, as a whole. For example, a given one of the first and second multipliers can be one of ⅕, ⅓, ⅔, ¾, and the like.

In some non-limiting embodiments of the present technology, the first multiplier, to be assigned to the first coordinates 507, can depend from the second multiplier, to be assigned to the second coordinates 509. In other words, in these embodiments, for example, the second multiplier can be a function of the first multiplier. In some non-limiting embodiments of the present technology, the function can be a linear function. In these embodiments, the second multiplier can depend from the first multiplier according to a following equation:

t₂=1−t₁, (Equation 1)

where t₁ is the first multiplier; and
t₂ is the second multiplier.

Put it another way, according to certain non-limiting embodiments of the present technology, to determine the respective synthetic coordinates 603 of the given vertex 306, the electronic device 204 can be configured to apply, to the first and second raw coordinates 507, 509, a linear interpolation algorithm. Other examples of the functions defining dependency between the second and first multiplier, and hence defining other interpolation algorithms, can include, without limitation, a power function, such as a square or cubic function, an exponential function, and a logarithmic function, as an example.

Thus, in these embodiments, for generating the synthetic instance of the given digital object 305 in the given synthetic frame 602, the electronic device 204 can be configured to: (i) assign, to the first multiplier, a given value; (ii) determine, based on a selected functional dependency, such as that defined by Equation 1, a value of the second multiplier; (iii) apply the so determined values of the first and second multipliers to the first and second coordinates 507, 509 of the given vertex 306 in the first and second raw frames 502, 504, respectively; and (iv) determine the respective synthetic coordinates 603 of the given vertex 306 in the given synthetic frame 602. For example, if the first multiplier has a value of ⅓, the second multiplier, according to the function defined in Equation 1, will be ⅔.

Thus, by applying the above approach to each vertex defining the surface of the given digital object 305 in each one of the first and second raw frames 502, 504, the electronic device 204 can be configured to generate a synthetic instance of the given digital object 305 in the given synthetic frame 602. Similarly, according to certain non-limiting embodiments of the present technology, the electronic device 204 can be configured to determine, for each mesh element defining the surface of the synthetic instance of the given digital object 305, the respective value of the textural parameter. More specifically, in these embodiments, the electronic device 204 can be configured to determine, for a given mesh element of the synthetic instance of the given digital object 305 in the given synthetic frame 602, the respective value of the textural parameter as being an average value between values of the textural parameter of the given mesh elements in the respective instances of the given digital object 305 in the first and second raw frames 502, 504. In other words, the electronic device 204 can be configured to use the first and second raw frames 502, 504 as texture atlases for applying textures to the mesh elements of the synthetic instance of the given digital object 305 in the given synthetic frame 602. It is contemplated that to determine the respective value of the textural parameter for given mesh element of the synthetic instance of the given digital object 305 for generating the given synthetic frame 602, the electronic device 204 can be configured to use any combination between the values of the textural parameter of the given mesh element in the respective instances of the given digital object 305 in the first and second raw frames 502, 504 such as a linear combination, any functional dependency and others.

Further, according to certain non-limiting embodiments of the present technology, the electronic device 204 is configured to place the given synthetic frame 602 between the first and second raw frames 502, 504 in the raw video sequence 302. By doing so, the electronic device 204 can be configured to generate the augmented video sequence 402 having twice as many frames than the raw video sequence 302. Continuing with the above example where the raw video sequence 302 had the first number of frames suitable for the playback at 24 FPS, the augmented video sequence 402 could thus have a second number of frames such that when the augmented video sequence 402 is played back at 48 FPS, a given second of the playback duration thereof includes 48 frames.

Further, in some non-limiting embodiments of the present technology, the electronic device 204 can be configured to generate more than one synthetic frame for placement thereof between the given pair of sequentially following raw frames, like the first and second raw frames 502, 504 mentioned above. For example, in some non-limiting embodiments of the present technology, by modifying at least one of the first and second multipliers applied to the first and raw second coordinates 507, 509 of the given vertex 306, thereby redetermining values of the respective synthetic coordinates 603 thereof, the electronic device 204 can be configured to generate a second synthetic instance of the given digital object 305 for a second synthetic frame (not depicted). According to certain non-limiting embodiments of the present technology, the electronic device 204 can be configured to modify the values of both the first and second multipliers. For example, in the embodiments where the second multiplier depends from the first multiplier functionally, such as according to Equation 1, the electronic device 204 can be configured to modify the value of the first multiplier to modify the value of the second multiplier as well. For example, if for generating the given synthetic frame 602, the first multiplier was ⅓ and the second multiplier was hence ⅔, for generating the second synthetic frame, the electronic device 204 can be configured to assign a value ⅔ to the first multiplier, thereby determining the value for the second multiplier as being ⅓.

Further, the electronic device 204 is configured to place the second synthetic frame, along with the given synthetic frame 602, between the first and second raw frames 502, 504 in the raw video sequence 302, thereby generating the augmented video sequence 402. Thus, if the raw video sequence 302 is initially configured for playback at 24 FPS, the augmented video sequence 402 having two synthetic frames between each given pair of sequentially following raw frames is configured for playback at 72 FPS. In other words, in this example, the augmented video sequence 402 has a third number of frames such that when the augmented video sequence 402 is played back at 72 FPS, a given second of the playback duration thereof includes 72 frames. As it can be appreciated, depending on a desired quality of the augmented video content 224, the electronic device 204 can be configured to place more synthetic frames between each given pair of sequentially following raw frames in the raw video sequence 302.

According to certain non-limiting embodiments of the present technology, the electronic device 204 can be configured to generate the augmented video sequence 402 in real time—that is, generate respective synthetic frames between pairs of sequentially following raw frames immediately prior to their playback to the user 206. In other non-limiting embodiments of the present technology, the electronic device 204 can be configured, first, to generate the augmented video sequence 402 of the augmented video content 224, and play back the augmented video content 224 thereafter.

Further, although in the embodiments described above, the electronic device 204 is configured to generate synthetic frames for the augmented video sequence 402 automatically; in other non-limiting embodiments of the present technology, the server 202 can be configured to cause the electronic device 204 to execute the respective steps described above to generate the augmented video sequence 402, such as by transmitting to the electronic device 204 respective executable instructions. Thus, in these embodiments, a specific number of synthetic frames to be added between each given pair of sequentially following raw frames in the raw video sequence 302 can be determined in a centralized manner, at the server 202, for multiple electronic devices implemented similarly to the electronic device 204.

Thus, according to certain non-limiting embodiments of the present technology, the electronic device 204 can be configured to generate the augmented video content 224 configured for a playback at the higher frame rate and hence having higher quality compared to the given video content 214, without the need to decode an initially composed high-quality video content. This may save computational resource of at least one of the processor 110 and the GPU 111 of the electronic device 204 allowing for smoother playback of the augmented video content 224 to the user 206, and improving a user experience thereof with the electronic device 204 and/or the entity associated with producing the given video content 214.

### Method

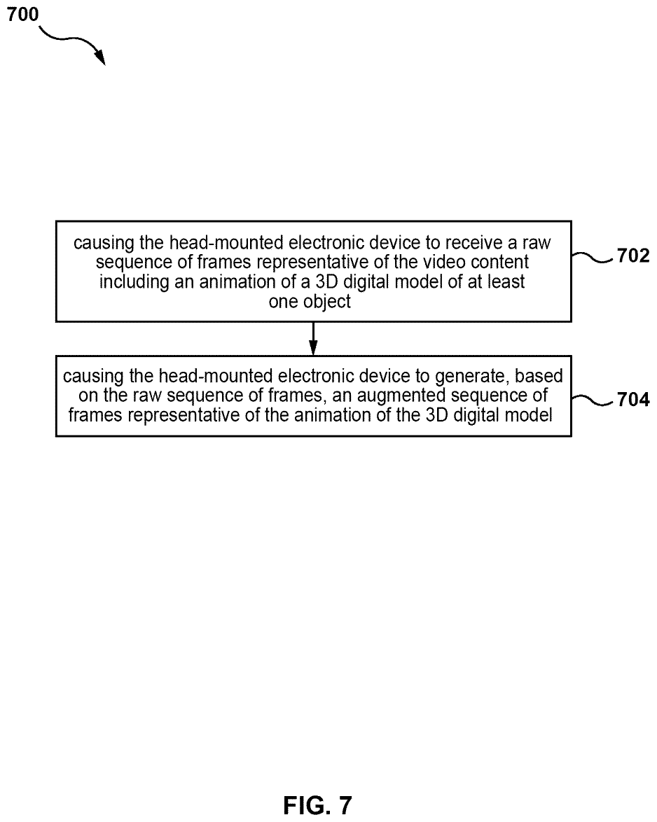

Given the architecture and the examples provided hereinabove, it is possible to execute a method for processing a video content, such as the given video content 214. With reference now to FIG. 7, there is depicted a flowchart of a method 700, according to the non-limiting embodiments of the present technology. As mentioned hereinabove, in some non-limiting embodiments of the present technology, the method 700 can be executed by the processor 110 of the electronic device 204. In some non-limiting embodiments of the present technology, the electronic device 204 can be caused to execute the method 700 by the server 202 transmitting respective executable instructions to the electronic device 204.

As mentioned hereinabove, according to certain non-limiting embodiments of the present technology, the given video content 214 comprises the raw video sequence 302 including a plurality of raw frames, such as that depicted in FIG. 3. According to certain non-limiting embodiments of the present technology, the given raw frame 304 of the raw video sequence 302 can include a representation of the respective instance of the given digital object 305, defining an animation thereof when the given video content 214 is played back, for example, by the electronic device 204.

In some non-limiting embodiments of the present technology, the given digital object 305 can be represented as the 3D digital model comprising a plurality of vertices, such as the given vertex 306, defining the surface of the given digital object 305 in the given raw frame 304.

### Step 702: Causing the Head-Mounted Electronic Device to Receive a Raw Sequence of Frames Representative of the Video Content Including an Animation of a 3D Digital Model of at Least One Object

At step 702, the electronic device 204 can be configured to receive the given video content 214. To that end, as mentioned above with reference to FIG. 2, the electronic device 204 can be configured to submit the video content request 212 to the server 202 where the given video content 214 has been composed and/or is stored. More specifically, as described further above with reference to FIG. 2, in some non-limiting embodiments of the present technology, the server 202 can be configured to: (i) receive, from the electronic device 204, the video content request 212; (ii) identify, in the video content database 218, the given video content 214 responsive to the video content request 212; (ii) compress the given video content 214 to generate the compressed video data package 216; and (iii) transmit the compressed video data package 216 to the electronic device 204 for further presentation of the given video content 214 to the user 206.

As mentioned further above with reference to FIG. 3, in some non-limiting embodiments of the present technology, when compressing the given video content 214, the server 202 can also be configured to encode: (1) coordinates of vertices of each mesh element defining the surface of the given digital object 305 in each raw frame of the raw video sequence 302, such as the respective coordinates 307 of the given vertex 306 in the given raw frame 304; and (2) the respective value of the textural parameter to be applied to each mesh element.

The method 700 hence advances to step 704.

### Step 704: Causing the Head-Mounted Electronic Device to Generate, Based on the Raw Sequence of Frames, an Augmented Sequence of Frames Representative of the Animation of the 3D Digital Model

At step 704, according to certain non-limiting embodiments of the present technology, the electronic device can be configured to augment the raw video sequence 302, thereby generating the augmented video sequence 402. To that end, according to certain non-limiting embodiments of the present technology, the electronic device 204 can be configured to: (i) generate, for each given pair of sequentially following raw frames, at least one synthetic frame including a respective synthetic representation of the given digital object 305; and (ii) place the at least one synthetic frame between the given pair of sequentially following raw frames.

For example, as described above with reference to FIGS. 5 and 6, the electronic device 204 can be configured to generate the given synthetic frame 602 including the respective synthetic instance of the given digital object 305; and place the given synthetic frame 602 between the first and second raw frames 502, 504.

To generate the given synthetic frame 602, according to certain non-limiting embodiments of the present technology, the electronic device 204 can be configured to: (i) receive, for each one of the first and second raw frames 502, 504 of the raw video sequence 302, the first and second raw coordinates 507, 509 of the given vertex 306 defining the surface of the given digital object 305 in the first and second raw frames 502, 504; (ii) based on the first and second raw coordinates 507, 509 of the given vertex 306, determine the respective synthetic coordinates 603 of the given vertex 306; and (iii) based on the so determined respective synthetic coordinates of each vertex defining the given digital object 305 in the first and second raw frames 502, 504, generate the respective synthetic instance of the given digital object 305 for the given synthetic frame 602.

According to certain non-limiting embodiments of the present technology, the electronic device 204 can be configured to determine the respective synthetic coordinates 603 of the given vertex 306 by determining a combination of the first and second raw coordinates 507, 509 of the given vertex 306 in the first and second raw frames 502, 504. In some non-limiting embodiments of the present technology, the combination of the first and second raw coordinates 507, 509 comprises an average value thereof. In other non-limiting embodiments of the present technology, the combination of the first and second raw coordinates 507, 509 comprises a weighted average value thereof.

More specifically, in some non-limiting embodiments of the present technology, the electronic device 204 can be configured to (i) assign, to each one of the first and second raw coordinates 507, 509, the first and second multiplier, respectively; and (ii) determine the average value of the so weighted raw coordinates. In some non-limiting embodiments of the present technology, the first and second multipliers can be equal. In other non-limiting embodiments of the present technology, the first and second multipliers to be assigned to the first and second raw coordinates 507, 509 can be different. It is not limited how the first and second multipliers can be selected; and in some non-limiting embodiments of the present technology, these multipliers can be selected empirically, maximizing at least one of a quality of the given synthetic frame 602 or the augmented video sequence 402, as a whole. For example, a given one of the first and second multipliers can be one of ⅕, ⅓, ⅔, ¾, and the like.

In some non-limiting embodiments of the present technology, the first multiplier, to be assigned to the first coordinates 507, can depend from the second multiplier, to be assigned to the second coordinates 509. In other words, in these embodiments, for example, the second multiplier can be a function of the first multiplier. In some non-limiting embodiments of the present technology, the function can be a linear function, such as that expressed by Equation 1 above.

In other words, according to certain non-limiting embodiments of the present technology, to determine the respective synthetic coordinates 603 of the given vertex 306, the electronic device 204 can be configured to apply, to the first and second raw coordinates 507, 509, the linear interpolation algorithm.

Thus, by applying the above approach to each vertex defining the surface of the given digital object 305 in each one of the first and second raw frames 502, 504, the electronic device 204 can be configured to generate the synthetic instance of the given digital object 305 for the given synthetic frame 602. As described in detail further above, according to certain non-limiting embodiments of the present technology, the electronic device 204 can be configured to determine, for each mesh element defining the surface of the synthetic instance of the given digital object 305, the respective value of the textural parameter.

Further, according to certain non-limiting embodiments of the present technology, the electronic device 204 is configured to place the given synthetic frame 602 between the first and second raw frames 502, 504 in the raw video sequence 302. By doing so, the electronic device 204 can be configured to generate the augmented video sequence 402 having twice as many frames than the raw video sequence 302. For example, if the raw video sequence 302 has the first number of frames suitable for the playback at 24 FPS, as described above with reference to FIG. 4, the augmented video sequence 402 could thus have the second number of frames such that when the augmented video sequence 402 is played back at 48 FPS, each given second of the playback duration thereof includes 48 frames.

Further, according to certain non-limiting embodiments of the present technology, the electronic device 204 can be configured to generate more synthetic frames for placement thereof between each given pair of sequentially following raw frames. More specifically, in this regard, the electronic device 204 can be configured to modify the values of the first and second multipliers applied to the first and second raw coordinates 507, 506 of the given vertex 306, thereby re-determining the values of the respective synthetic coordinates 603 of the given vertex. By doing so, the electronic device 204 can be configured to generate other synthetic frames to be placed between the first and second raw frames 502, 504, thereby proportionally increasing the playback speed of the augmented video sequence 402.

According to certain non-limiting embodiments of the present technology, the electronic device 204 can be configured to generate the augmented video sequence 402 in real time—that is, generate respective synthetic frames between pairs of sequentially following raw frames immediately prior to their playback to the user 206. In other non-limiting embodiments of the present technology, the electronic device 204 can be configured, first, to generate the augmented video sequence 402 of the augmented video content 224, and play back the augmented video content 224 thereafter.

Also, as mentioned hereinabove, in some non-limiting embodiments of the present technology, the execution of each step 702, 704 at the electronic device 204 can be caused by the server 202. In other non-limiting embodiments of the present technology, the electronic device 204 can be configured to execute the steps of the method 700 automatically, independently of the server 202.

The method 700 hence terminates.

It should be expressly understood that not all technical effects mentioned herein need to be enjoyed in each and every embodiment of the present technology.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

1. A computer-implemented method for processing a video content for presentation to a user of a head-mounted electronic device, the method comprising:
causing the head-mounted electronic device to receive a raw sequence of frames representative of the video content including an animation of a 3D digital model of at least one object,
the 3D digital object comprises a plurality of vertices defining a surface of the at least one object in each one of the raw sequence of frames;
the raw sequence of frames including a first plurality of frames configured for playback at a first frame rate;
causing the head-mounted electronic device to generate, based on the raw sequence of frames, an augmented sequence of frames representative of the animation of the 3D digital model, the generating comprising:
generating content for a given synthetic frame, the generating comprising:
identifying, in a given pair of sequentially following frames of the raw sequence of frames, respective instances of the 3D digital model;
based on the respective instances of the 3D digital model in the given pair of sequentially following frames, generating a synthetic instance of the 3D digital model; and
placing the given synthetic frame between the given pair of sequentially following frames, thereby generating the augmented sequence of frames including a second plurality of frames configured for playback at a second frame rate, greater than the first frame rate.

2. The method of claim 1, wherein the generating the synthetic instance of the 3D digital model comprises determining, for each one of the plurality of vertices defining the surface of the 3D digital model, respective synthetic coordinates within the given synthetic frame, determining the respective synthetic coordinates for a given vertex of the plurality of vertices comprising:
determining first coordinates of the given vertex within the respective instance of the 3D digital model in a first frame of the given pair of sequentially following frames of the raw sequence of frames;
determining second coordinates of the given vertex within the respective instance of the 3D digital model in a second frame of the given pair of sequentially following frames of the raw sequence of frames;
applying, to the first coordinates, a first multiplier to generate first modified coordinates;
applying, to the second coordinates, a second multiplier to generate second modified coordinates,
the second multiplier being different from the first multiplier; and
determining a combination between the first and second modified coordinates.

3. The method of claim 2, wherein each one of the first and second multipliers have been predetermined.

4. The method of claim 2, wherein each one of the first and second multipliers are less than 1.

5. The method of claim 2, wherein the second multiplier depends from the first multiplier.

6. The method of claim 2, wherein the second multiplier depends from the first multiplier according to a following equation:
t₂=1−t₁,
where t₁ is the first multiplier; and
t₂ is the second multiplier.

7. The method of claim 2, further comprising:
modifying at least one of the first and second multipliers to generate an other synthetic frame;
placing the given and other synthetic frames between the given pair of sequentially following frames, thereby generating the augmented sequence of frames including a third plurality of frames configured for playback at a third frame rate, greater than the second frame rate, during the given playback period.

8. The method of claim 2, wherein the determining, for each one of the plurality of vertices defining the surface of the 3D digital model, the respective synthetic coordinates within the given synthetic frame comprises applying a linear interpolation algorithm to coordinates of the plurality of vertices of the 3D digital model in the first and second frames of the given pair of sequentially following frames of the raw sequence of frames.

9. The method of claim 1, further comprising causing the head-mounted electronic device to play back the augmented sequence of frames at the second frame rate.

10. The method of claim 1, wherein the generating the augmented sequence of frames is executed in real time, during the playback thereof.

11. The method of claim 1, wherein the head-mounted electronic device is one of Virtual Reality (VR) and Augmented Reality (AR) glasses.

12. A computing device for processing a video content for presentation to a user of the computing device, the computing device comprising at least one processor and at least one non-transitory computer-readable memory comprising executable instructions, which, when executed by the at least one processor, cause the computing device to execute steps of:
receiving a raw sequence of frames representative of the video content including an animation of a 3D digital model of at least one object,
the 3D digital object comprises a plurality of vertices defining a surface of the at least one object in each one of the raw sequence of frames;
the raw sequence of frames including a first plurality of frames configured for playback at a first frame rate; and
generating, based on the raw sequence of frames, an augmented sequence of frames representative of the animation of the 3D digital model, the generating comprising:
generating content for a given synthetic frame, the generating comprising:
identifying, in a given pair of sequentially following frames of the raw sequence of frames, respective instances of the 3D digital model;
based on the respective instances of the 3D digital model in the given pair of sequentially following frames, generating a synthetic instance of the 3D digital model; and
placing the given synthetic frame between the given pair of sequentially following frames, thereby generating the augmented sequence of frames including a second plurality of frames configured for playback at a second frame rate, greater than the first frame rate.

13. The computing device of claim 12, wherein to generate the synthetic instance of the 3D digital model, the at least one processor causes the computing device to determine, for each one of the plurality of vertices defining the surface of the 3D digital model, respective synthetic coordinates within the given synthetic frame, determining the respective synthetic coordinates for a given vertex of the plurality of vertices comprising:
determining first coordinates of the given vertex within the respective instance of the 3D digital model in a first frame of the given pair of sequentially following frames of the raw sequence of frames;
determining second coordinates of the given vertex within the respective instance of the 3D digital model in a second frame of the given pair of sequentially following frames of the raw sequence of frames;
applying, to the first coordinates, a first multiplier to generate first modified coordinates;
applying, to the second coordinates, a second multiplier to generate second modified coordinates,
the second multiplier being different from the first multiplier; and
determining a combination between the first and second modified coordinates.

14. The computing device of claim 13, wherein the second multiplier depends from the first multiplier according to a following equation:
t₂=1−t₁,
where t₁ is the first multiplier; and
t₂ is the second multiplier.

15. The computing device of claim 13, wherein the at least one processor further causes the computing device to:
modify at least one of the first and second multipliers to generate an other synthetic frame;
place the given and other synthetic frames between the given pair of sequentially following frames, thereby generating the augmented sequence of frames including a third plurality of frames configured for playback at a third frame rate, greater than the second frame rate, during the given playback period.

16. The computing device of claim 13, wherein to determine, for each one of the plurality of vertices defining the surface of the 3D digital model, the respective synthetic coordinates within the given synthetic frame, the at least one processor causes the computing device to apply a linear interpolation algorithm to coordinates of the plurality of vertices of the 3D digital model in the first and second frames of the given pair of sequentially following frames of the raw sequence of frames.

17. The computing device of claim 12, wherein the at least one processor causes the computing device to play back the augmented sequence of frames at the second frame rate.

18. The computing device of claim 12, wherein the at least one processor causes the computing device to generate the augmented sequence of frames in real time, during the playback thereof.

19. The computing device of claim 12, wherein the computing device is one of Virtual Reality (VR) and Augmented Reality (AR) glasses.

20. The computing device of claim 12, wherein the computing device is a server communicative coupled to a plurality of electronic devices,
the server being configured to cause execution of the steps of (i) the receiving the raw sequence of frames; and (ii) the generating the augmented sequence of frames at a given one of the plurality of electronic devices.
